(19) United States
(12) Patent Application Publication
(10) Pub. No.: US 2025/0048245 A1
(43) Pub. Date: Feb. 6, 2025

(54) CELL SELECTION AND RESELECTION IN A RELAY-ASSISTED WIRELESS NETWORK

(71) Applicant: Telefonaktiebolaget LM Ericsson (publ), Stockholm (SE)

(72) Inventors: Jingya LI, GÖTEBORG (SE); Adrián LAHUERTA LAVIEJA, MÖLNDAL (SE); Xingqin LIN, SAN JOSÈ, CA (US); Zhiqiang QI, BEIJING (CN); Ajmal MUHAMMAD, SOLLENTUNA (SE)

(73) Assignee: Telefonaktiebolaget LM Ericsson (publ), Stockholm (SE)

(21) Appl. No.: 18/709,087

(22) PCT Filed: Nov. 11, 2021
(86) PCT No.: PCT/CN2021/130024

§ 371 Date: May 10, 2024

(51) Int. Cl. H04W 48/20; H04W 36/30

(52) U.S. Cl. CPC H04W 48/20; H04W 36/30

(57) ABSTRACT

There is provided mechanisms for assist cell selection or reselection in a relay-assisted wireless network. A method is performed by a network node. The method comprises providing, towards a user equipment that has an end-to-end wireless link composed of a wireless access link and at least one wireless backhaul link between itself and a donor node of the relay-assisted wireless network, backhaul link characteristics of the at least one wireless backhaul link. The backhaul link characteristics assist the user equipment to derive an end-to-end wireless link quality metric for the end-to-end wireless link when performing a cell selection or a reselection procedure.

### TECHNICAL FIELD

Embodiments presented herein relate to a method, a network node, a computer program, and a computer program product for assisting cell selection or reselection in a relay-assisted wireless network. Embodiments presented herein further relate to a method, a user equipment, a computer program, and a computer program product for cell selection or reselection in a relay-assisted wireless network.

### BACKGROUND

A heterogeneous public or private wireless network where relay nodes, e.g., integrated access and backhaul (IAB) nodes, can be used to extend, enhance, or even re-establish network coverage and/or quality of service (QOS) over a geographical area of interest (e.g., urban areas with high demands on capacity, disaster-struck areas where first-responder communication is critical). Such networks are hereinafter referred to as relay-assisted wireless networks. A relay-assisted wireless network might comprise multiple relay nodes and the system architecture can be configured in a flexible and scalable way via multi-hop wireless backhauling, using the same or different frequency bands for access links and backhaul links.

Taking IAB nodes as a non-limiting and illustrative example of relay nodes, aspects of IAB based networks is for New Radio (NR) telecommunication systems, also referred to as fifth generation (5G) telecommunication systems are specified in Release 16 of the third generation partnership project (3GPP) whereas enhancements are provided in Release 17. At least some of these aspects are based on the Central Unit (CU) Distributed Unit (DU) split architecture of NR, where the IAB node will be hosting a DU part that is controlled by the CU. The IAB nodes also have a Mobile Termination (MT) part that they use to communicate with their parent nodes.

FIG. 1 is a schematic diagram illustrating a relay-assisted wireless network 100. The relay-assisted wireless network 100 could represent an IAB network for the NR standalone mode. The relay-assisted wireless network 100 comprises a core network 110 to which a network node 200 in the form of a donor node 240 is operatively connected. In turn, the donor node 240 is operatively connected to network nodes 200 in the form of relay nodes 250a: 250e over wireless backhaul links 120. The relay nodes 250a: 250e serve user equipment (UE) 300a: 300c over wireless access link 130. As illustrated in FIG. 1, the donor node 240 comprises a CU control plane (CP) module 242, a CU user plane (UP) module 244, DUs 248a, 248b, as well as one or more modules 246 for other functionality. In this respect, although the donor node 240 can be treated as a single logical node, in a deployment, the donor node 240 can be split according to these functions, which can all be either collocated or non-collocated. There is also a respective DU in each of the relay nodes 250a: 250e.

A user equipment 300a: 300c searching for a suitable cell to camp on performs initial cell (re-) selection based on the quality of the wireless access link, e.g., by means of reference signal received power (RSRP) measurements or reference signal received quality (RSRQ) measurements of cell specific reference signals from difference cells. Each such cell might be represented by one or more of the relay nodes 250a: 250e. Furthermore, dedicated radio resource control (RRC) signaling might be used to provide the user equipment with a list of blacklisted and whitelisted cells as well as a list of cell specific offsets. The cell specific offset for each network node (such as a relay node or donor node) is set by the mobile network operator and is typically used to artificially extend the coverage area of a low power node (also known as cell range extension) and in this way offload some traffic from macro base stations. The latter is known as load balancing. The cell (re) selection is then performed based on the information provided by the network.

In a relay-assisted wireless network, the donor node, or more exactly the CU-CP module 242 and the CU-UP module 244, has full control of all the wireless backhaul links and the relay nodes under its domain. The donor node can therefore redirect or handover a user equipment 300a: 300c to another relay node 250a: 250e if any wireless backhaul link (along the end-to-end path between the user equipment 300a: 300c and the donor node 240) experiences signaling problems. This can be used to address cell selection and reselection in relay-assisted wireless network to some extent (as long as the wireless backhaul link is still functioning even with bad signal quality; i.e. as long as there is not any radio link failure on the wireless backhaul link). However, this approach can introduce extra latency and unnecessary signaling overhead if a user equipment 300a: 300c anyway needs to be redirected or handed over to a second relay node 250a: 250e after initially connecting to a first relay node 250a: 250e.

Hence, there is still a need for improved cell selection and reselection in relay-assisted wireless networks.

### SUMMARY

An object of embodiments herein is to address the above issues.

A particular object is to provide techniques for cell selection and reselection that can proactively avoid a user equipment connecting to a relay node with low signal quality or congested backhaul link in relay-assisted wireless networks.

According to a first aspect there is presented a method for assist cell selection or reselection in a relay-assisted wireless network. The method is performed by a network node. The method comprises providing, towards a user equipment that has an end-to-end wireless link composed of a wireless access link and at least one wireless backhaul link between itself and a donor node of the relay-assisted wireless network, backhaul link characteristics of the at least one wireless backhaul link. The backhaul link characteristics assist the user equipment to derive an end-to-end wireless link quality metric for the end-to-end wireless link when performing a cell selection or a reselection procedure.

According to a second aspect there is presented a network node for assist cell selection or reselection in a relay-assisted wireless network. The network node comprises processing circuitry. The processing circuitry is configured to cause the network node to provide, towards a user equipment that has an end-to-end wireless link composed of a wireless access link and at least one wireless backhaul link between itself and a donor node of the relay-assisted wireless network, backhaul link characteristics of the at least one wireless backhaul link. The backhaul link characteristics assist the user equipment to derive an end-to-end wireless link quality metric for the end-to-end wireless link when performing a cell selection or a reselection procedure.

According to a third aspect there is presented a network node for assist cell selection or reselection in a relay-assisted wireless network. The network node comprises a provide module configured to provide, towards a user equipment that has an end-to-end wireless link composed of a wireless access link and at least one wireless backhaul link between itself and a donor node of the relay-assisted wireless network, backhaul link characteristics of the at least one wireless backhaul link. The backhaul link characteristics assist the user equipment to derive an end-to-end wireless link quality metric for the end-to-end wireless link when performing a cell selection or a reselection procedure.

According to a fourth aspect there is presented a computer program for assisting cell selection or reselection in a relay-assisted wireless network, the computer program comprising computer program code which, when run on processing circuitry of a network node, causes the network node to perform a method according to the first aspect.

According to a fifth aspect there is presented a method for cell selection or reselection in a relay-assisted wireless network. The method is performed by a user equipment. The user equipment has an end-to-end wireless link composed of a wireless access link and at least one wireless backhaul link between itself and a donor node of the relay-assisted wireless network. The method comprises receiving, from a relay node of the relay-assisted wireless network, backhaul link characteristics of the at least one wireless backhaul link. The method comprises deriving an end-to-end wireless link quality metric for the end-to-end wireless link between the user equipment and the donor node from access link characteristics of the wireless access link and the received backhaul link characteristics. The method comprises performing a cell selection or a reselection procedure with the relay node based on the end-to-end wireless link quality metric.

According to a sixth aspect there is presented a user equipment for cell selection or reselection in a relay-assisted wireless network. The user equipment is configured to have an end-to-end wireless link composed of a wireless access link and at least one wireless backhaul link between itself and a donor node of the relay-assisted wireless network. The user equipment comprises processing circuitry. The processing circuitry is configured to cause the user equipment to receive, from a relay node of the relay-assisted wireless network, backhaul link characteristics of the at least one wireless backhaul link. The processing circuitry is configured to cause the user equipment to derive an end-to-end wireless link quality metric for the end-to-end wireless link between the user equipment and the donor node from access link characteristics of the wireless access link and the received backhaul link characteristics. The processing circuitry is configured to cause the user equipment to perform a cell selection or a reselection procedure with the relay node based on the end-to-end wireless link quality metric.

According to a seventh aspect there is presented a user equipment for cell selection or reselection in a relay-assisted wireless network. The user equipment is configured to have an end-to-end wireless link composed of a wireless access link and at least one wireless backhaul link between itself and a donor node of the relay-assisted wireless network. The user equipment comprises a receive module configured to receive, from a relay node of the relay-assisted wireless network, backhaul link characteristics of the at least one wireless backhaul link. The user equipment comprises a derive module configured to derive an end-to-end wireless link quality metric for the end-to-end wireless link between the user equipment and the donor node from access link characteristics of the wireless access link and the received backhaul link characteristics. The user equipment comprises a select/reselect module configured to perform a cell selection or a reselection procedure with the relay node based on the end-to-end wireless link quality metric.

According to an eighth aspect there is presented a computer program for cell selection or reselection in a relay-assisted wireless network, the computer program comprising computer program code which, when run on processing circuitry of a user equipment, causes the user equipment to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient cell selection or reselection for a user equipment in a relay-assisted wireless network.

Advantageously, these aspects ensure that a good end-to-end wireless path is selected for the user equipment when performing cell selection or reselection to connect to a relay-assisted wireless network.

Advantageously, compared to existing techniques based on redirection, or handover, from one relay node to another, the herein disclosed embodiments can help to avoid a user equipment selecting a bad end-to-end wireless path from the beginning. This is ensured by handling the issue in proactive way.

Advantageously, compared to existing techniques, the herein disclosed embodiments reduce the latency and unnecessary signaling overhead, as otherwise required for redirecting, or handing over, the user equipment from one relay node to another due to issues with wireless backhaul links.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 and 4 are schematic diagrams illustrating a relay-assisted wireless network according to embodiments;

FIGS. 2 and 3 are flowcharts of methods according to embodiments;

FIG. 5 is a schematic diagram showing functional units of a network node according to an embodiment;

FIG. 6 is a schematic diagram showing functional modules of a network node according to an embodiment;

FIG. 7 is a schematic diagram showing functional units of a user equipment according to an embodiment;

FIG. 8 is a schematic diagram showing functional modules of a user equipment according to an embodiment; and

FIG. 9 shows one example of a computer program product comprising computer readable means according to an embodiment.

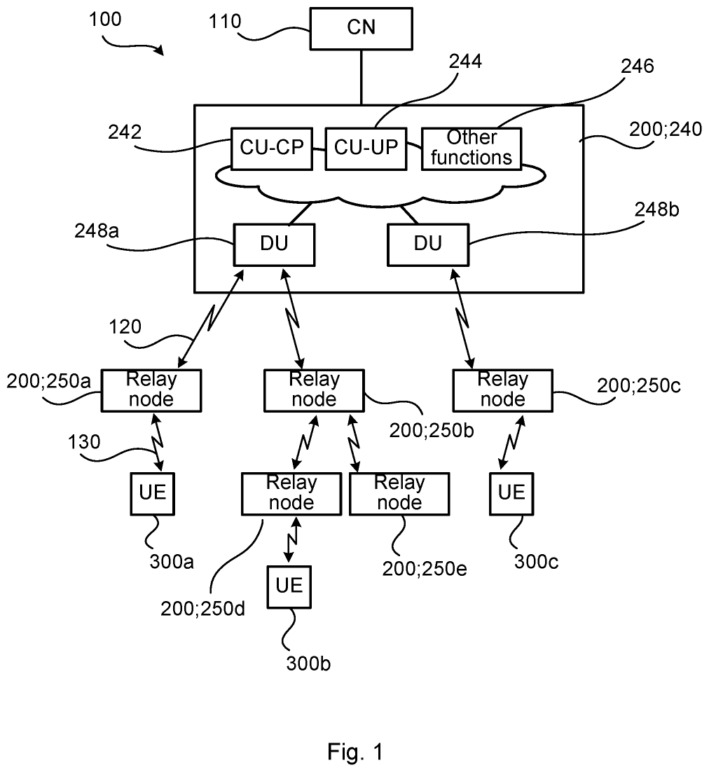

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved cell selection and reselection in relay-assisted wireless networks.

In further detail, as disclosed above, cell selection is performed only based on the quality of the wireless access link, e.g., by means of RSRP/RSRQ measurements of cell specific reference signals from different cells. This is appropriate in traditional network topologies where the wireless access link is the only wireless link. However, relay-assisted wireless networks may include one or several wireless backhaul links between a donor node 240 and a relay node 250a: 250e providing network access to a user equipment 300a: 300c and could therefore benefit from new techniques that can assist a user equipment 300a: 300c to perform better cell selection and/or reselection with the awareness of the end-to-end path quality (i.e., considering both the wireless backhaul links and the wireless access links).

In a relay-assisted wireless network, the selection of an end-to-end path between a user equipment 300a: 300c and a donor node 240 (i.e., the network node that is directly connected to the core network 110) can significantly impact the service performance (e.g., throughput, latency, etc.) for the user equipment 300a: 300c. This is because the service performance depends on the quality of both the wireless access link and the wireless backhaul link(s). Applying existing cell selection or reselection techniques in a relay-assisted wireless network might result in the user equipment 300a: 300c selecting a relay node which provides the best access link quality, but it may have bad wireless backhaul connection.

The embodiments disclosed herein therefore relate to mechanisms for assisting cell selection or reselection in a relay-assisted wireless network 100 and for cell selection or reselection in a relay-assisted wireless network 100. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a user equipment 300a: 300c, a method performed by the user equipment 300a: 300c, and a computer program product comprising code, for example in the form of a computer program, that when run on processing circuitry of the user equipment 300a: 300c, causes the user equipment 300a: 300c to perform the method.

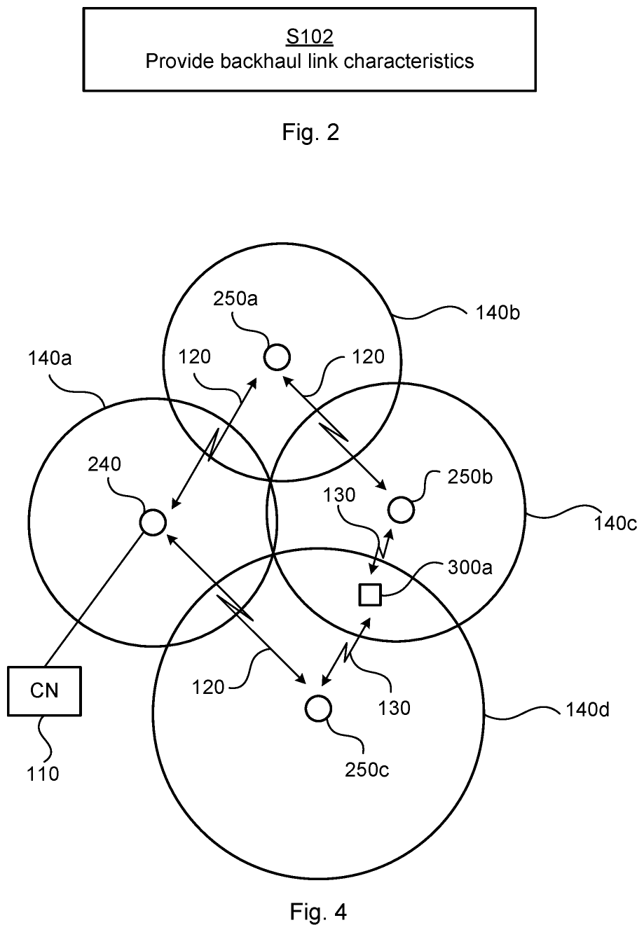

Reference is now made to FIG. 2 illustrating a method for assisting cell selection or reselection in a relay-assisted wireless network 100 as performed by the network node 200 according to an embodiment.

S102: The network node 200 provides backhaul link characteristics of the at least one wireless backhaul link 120 towards a user equipment 300a: 300c. The backhaul link characteristics is provided to a user equipment 300a: 300c having an end-to-end wireless link composed of a wireless access link 130 and at least one wireless backhaul link 120 between itself and a donor node 240 of the relay-assisted wireless network 100. The backhaul link characteristics assist the user equipment 300a: 300c to derive an end-to-end wireless link quality metric for the end-to-end wireless link when performing a cell selection or a reselection procedure.

In some aspects the method is performed by a relay node 250a: 250e. That is, in some embodiments, the network node 200 is a relay node 250a: 250e, such as an IAB node or a repeater, of the relay-assisted wireless network 100. In other aspects the method is performed by the donor node 240. That is, in some embodiments, the network node 200 is the donor node 240.

Embodiments relating to further details of for assisting cell selection or reselection in a relay-assisted wireless network 100 as performed by the network node 200 will now be disclosed.

There may be different examples of backhaul link characteristics. In some non-limiting examples, the backhaul link characteristics pertain to any of: current or predicted quality of the at least one wireless backhaul link 120, performance of the at least one wireless backhaul link 120, or/and configuration of the at least one wireless backhaul link 120.

In some aspects, the network node 200 transmits a set of wireless backhaul related parameters to the user equipment 300a: 300c for assisting the user equipment 300a: 300c to perform cell selection or reselection with end-to-end wireless path performance awareness. In particular, in some embodiments, the backhaul link characteristics are provided as a set of wireless backhaul related parameters.

There could be different ways for the wireless backhaul related parameters to be provided towards the user equipment 300a: 300c. In some embodiments, the wireless backhaul related parameters are provided towards the user equipment 300a: 300c by being broadcasted as system information or transmitted using dedicated radio resource control (RRC) signalling. The set of wireless backhaul related parameters might be broadcasted as Minimum System Information (MSI), such as in the system information block 1 (SIB1) or the Master Information Block (MIB), e.g., used for the user equipment 300a: 300c to perform cell selection or reselection when it is in RRC IDLE mode. In some examples, the wireless backhaul related parameters are transmitted using dedicated RRC signaling, e.g., used for assisting the user equipment 300a: 300c to select a proper cell when performing handover. For instance, the wireless backhaul related parameters might be part of an RRC messages for conditional handover.

In some examples, whether the set of wireless backhaul related parameters is to be transmitted from a given network node or node depends on the network node type. For instance, the set of wireless backhaul related parameters is only provided in the above-mentioned messages (e.g., SIB1, MIB, dedicated RRC signaling) of a network node if this network node relies on a wireless backhaul connection to be able to connect to the core network. In other examples, the set of wireless backhaul related parameters is transmitted from all network nodes, and a default configuration is defined if a network node has a wired connection to the core network.

In some non-limiting examples, the wireless backhaul related parameters pertain to any of: RSRP of the at least one wireless backhaul link 120, RSRQ of the at least one wireless backhaul link 120, signal to noise ratio (SNR) of the at least one wireless backhaul link 120, signal to interference plus noise ratio (SINR) or the at least one wireless backhaul link 120, latency indicator of the at least one wireless backhaul link 120, capacity indicator of the at least one wireless backhaul link 120, load indicator of the at least one wireless backhaul link 120, priority indicator of the at least one wireless backhaul link 120, energy status indicator of the at least one wireless backhaul link 120.

Details relating at least some of the examples will be provided next.

The RSRP, RSRQ, SNR and SINR values indicate the quality of the wireless backhaul links that are used for connecting the relay nodes to the core network.

A wireless backhaul latency indicator provides a quantized value of latency, or congestion, for example based on the amount of traffic transported via the wireless backhaul link(s), and/or the number of backhaul channels established on each wireless backhaul link.

A wireless backhaul capacity indicator captures both SNR, SINR, and bandwidth.

A wireless backhaul load indicator signals the congestion level of the wireless backhaul link, e.g., in terms of the percentage of the backhaul capacity being used.

A priority indicator indicates the priority level of the associated end-to-end wireless link, e.g., whether the traffic over this end-to-end wireless link will be treated with higher priority compared to other links.

An energy status indicator indicates the current energy conditions of the relay nodes involved in the end-to-end wireless link. For instance, if one of the relay nodes involved in the end-to-end wireless link is about to run out of power, a flag can be sent for the user equipment 300a: 300c to not select this path in case the user equipment 300a: 300c has a large amount of traffic or critical data to send.

The set of wireless backhaul related parameters might first be collected by each of the relay nodes, and then provided from each of the relay nodes to the donor node, for example via signaling over the F1 interface. The donor node could thus maintain a set of wireless backhaul related parameters that can be dynamically updated as the network evolves. Furthermore, if a relay node is connected via more than one wireless backhaul link to the donor node then a separate set of wireless backhaul related parameters could be provided for each of the wireless backhaul links. In this respect, the relay node could either transmit the set of wireless backhaul related parameters for all the wireless backhaul links or only for the best wireless backhaul links (using a selection criterion based on these parameters) at a particular time instant. The donor node might itself derive the wireless backhaul related parameters and provide them to the relay nodes (which then further provide the wireless backhaul related parameters towards the user equipment 300a: 300c). Hence, in some embodiments, the wireless backhaul related parameters are derived by, or provided to the network node 200 from, the donor node 240 of the relay-assisted wireless network 100.

Further examples of how the set of wireless backhaul related parameters might be provided will be disclosed next.

In some examples, the set of wireless backhaul related parameters comprises a list of RSRP, or RSRQ, values for all the wireless backhaul links that connects a given relay node to the core network. Table 1 and Table 2 give examples of values of RSRP and RSRQ, respectively, for two wireless backhaul links (denoted BH1 and BH2) and one wireless access link (RP1) in a relay-assisted wireless network.

TABLE 1
RSRP values according to an example
RSRP [dBm]

| BH1 | BH2 | RP1 |
|---|---|---|
| −113 | −104 | −95 |

TABLE 2
RSRQ values according to an example
RSRQ [dB]

| BH1 | BH2 | RP1 |
|---|---|---|
| −36 | −27 | −18 |

In some examples, the set of wireless backhaul related parameters comprises a RSRP, or RSRQ, mean value (in terms of arithmetic mean or linear average), which is averaged over all RSRP, or RSRQ, values of all the wireless backhaul links that connects a given relay network node to the core network. For example, using the values in the example above, the reported linearly-averaged RSRP and/or RSRQ values would be:

$${RSRP}_{linear - average} ( dBm ) = {log}_{10} ( \frac{{10}^{( - 113 / 10 )} + {10}^{( - 104 / 10 )} + {10}^{( - 95 / 10 )}}{3} ) = - 99.2$$

$${RSRQ}_{linear - average} ( dB ) = {log}_{10} ( \frac{{10}^{( - 36 / 10 )} + {10}^{( - 27 / 10 )} + {10}^{( - 18 / 10 )}}{3} ) = - 22.2$$

For dB-averaged RSRP and/or RSRQ values, the reported values become:

$${RSRP}_{dB - average} ( dBm ) = \frac{( - 113 ) + ( - 104 ) + ( - 95 )}{3} = - 104$$

$${RSRQ}_{dB - average} ( dB ) = \frac{( - 36 ) + ( - 27 ) + ( - 18 )}{3} = - 27$$

In some examples, the set of wireless backhaul related parameters comprises a weighted average RSRP/RSRQ value, considering all the wireless backhaul links that connects a given relay node to the core network. For example, using the values in the example above and some example weights for BH1 (w=0.2), BH2 (w=0.3) and RP1 (w=0.5), the reported RSRP and/or RSRQ values would be:

$${RSRP}_{linear - weighted} ( dBm ) = {log}_{10} ( \frac{0.2 \times {10}^{( - 113 / 10 )} + 0.3 \times {10}^{( - 104 / 10 )} + 0.5 \times {10}^{( - 95 / 10 )}}{3} ) = - 102.44$$

$${RSRQ}_{linear - weighted} ( dB ) = {log}_{10} ( \frac{0.2 \times {10}^{( - 36 / 10 )} + 0.3 \times {10}^{( - 27 / 10 )} + 0.5 \times {10}^{( - 18 / 10 )}}{3} ) = - 25.44$$

or, for dB-averages:

$${RSRP}_{dB - weighted} ( dBm ) = \frac{0.2 \times ( - 113 ) + 0.3 \times ( - 104 ) + 0.5 \times ( - 95 )}{3} = - 33.77$$

$${RSRQ}_{dB - weighted} ( dB ) = \frac{0.2 \times ( - 36 ) + 0.3 \times ( - 27 ) + 0.5 \times ( - 18 )}{3} = - 8.1$$

In some examples, the set of wireless backhaul related parameters comprises a harmonic mean RSRP/RSRQ value, considering all the wireless backhaul links that connects a given relay node to the core network. For example, using the values in the example above the reported RSRP and/or RSRQ values would be:

$${RSRP}_{linear - harmonic} ( dBm ) = {log}_{10} ( \frac{3}{{10}^{( 113 / 10 )} + {10}^{( 104 / 10 )} + {10}^{( 95 / 10 )}} ) = - 108.8$$

$${RSRQ}_{linear - harmonic} ( dB ) = {log}_{10} ( \frac{3}{{10}^{( 36 / 10 )} + {10}^{( 27 / 10 )} + {10}^{( 18 / 10 )}} ) = - 31.8$$

or, for dB-averages:

$${RSRP}_{dB - harmonic} ( dBm ) = \frac{3}{\frac{1}{( - 113 )} + \frac{1}{( - 104 )} + \frac{1}{( - 95 )}} = - 103.48$$

$${RSRQ}_{dB - harmonic} ( dB ) = \frac{3}{\frac{1}{( - 36 )} + \frac{1}{( - 27 )} + \frac{1}{( - 18 )}} = - 24.92$$

In some examples, the set of wireless backhaul related parameters comprises the minimum RSRP, or RSRQ, value of all the wireless backhaul links that connect a given relay node to the core network. For example, using the values in the example above the reported RSRP and/or RSRQ values would be:

$${RSRP}_{min} ( dBm ) = - 113$$

$${RSRQ}_{min} ( dB ) = - 36$$

In some examples, the set of wireless backhaul related parameters comprises priority information. The priority information defines information indicating whether some type of traffic, or traffic for some user equipment 300a: 300c is prioritized through some of the wireless backhaul links or not.

In summary, in some examples, the wireless backhaul related parameters are provided as any of: a list of values, a mean value, a weighted average value, a harmonic mean value, a minimum value, a maximum value.

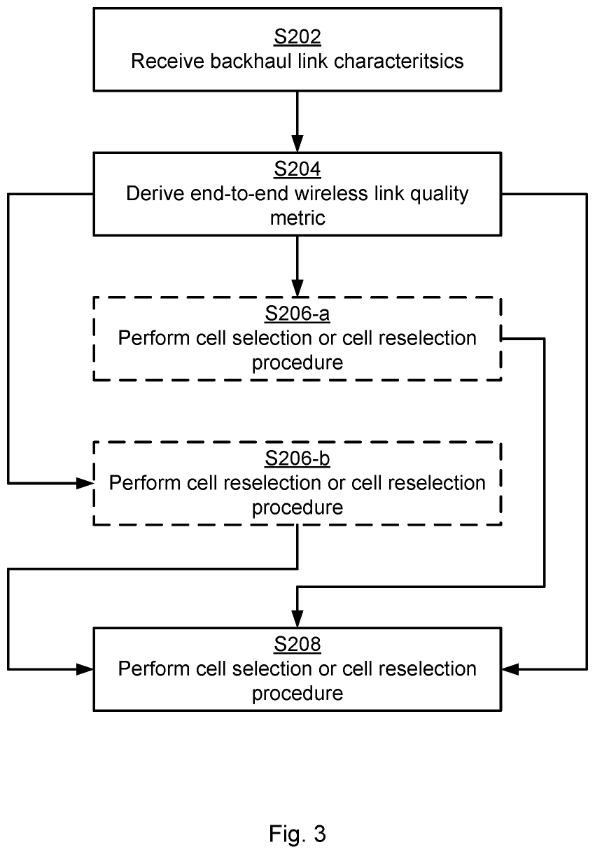

Reference is now made to FIG. 3 illustrating a method for cell selection or reselection in a relay-assisted wireless network 100 as performed by the user equipment 300a: 300c according to an embodiment. The user equipment 300a: 300c is assumed to have an end-to-end wireless link composed of a wireless access link 130 and at least one wireless backhaul link 120 between itself and a donor node 240 of the relay-assisted wireless network.

S202: The user equipment 300a: 300c receives, from a relay node 250a: 250e of the relay-assisted wireless network 100, backhaul link characteristics of the at least one wireless backhaul link 120.

The user equipment 300a: 300c uses the received backhaul link characteristics together with its channel measurements to perform cell selection or reselection, considering the performance of the end-to-end wireless link, including both wireless access links and wireless backhaul links.

S204: The user equipment 300a: 300c derives an end-to-end wireless link quality metric for the end-to-end wireless link between the user equipment 300a: 300c and the donor node 240 from access link characteristics of the wireless access link 130 and the received backhaul link characteristics.

S208: The user equipment 300a: 300c performs a cell selection or a reselection procedure with the relay node 250a: 250e based on the end-to-end wireless link quality metric.

Embodiments relating to further details of cell selection or reselection in a relay-assisted wireless network 100 as performed by the user equipment 300a: 300c will now be disclosed.

There may be different examples of access link characteristics. In some embodiments, the access link characteristics pertain to channel measurements of the wireless access link 130.

In some aspects, the user equipment 300a: 300c performs cell selection based on quality of the wireless access link to find a suitable cell to camp on. Hence, in some embodiments, it is the cell reselection procedure that is performed based on the end-to-end wireless link quality metric, and the user equipment 300a: 300c is further configured to perform optional step S206-a:

S206-a: The user equipment 300a: 300c performs a cell selection procedure with the relay node 250a: 250e of the relay-assisted wireless network 100 based on the access link characteristics.

In some aspects, the user equipment 300a: 300c performs cell selection by first evaluating the suitability of the wireless access link of each cell. For a cell with suitable wireless access link, the user equipment 300a: 300c further evaluate the suitability of the end-to-end wireless link including both the wireless access link and the wireless backhaul links. In the end, the user equipment 300a: 300c camps on the first cell that fulfills the end-to-end suitability. That is, in some embodiments, the cell selection procedure identifies a set of relay nodes 250a: 250e fulfilling an access link criterion as evaluated based on the access link characteristics, and during the cell reselection procedure a first available relay node 250a: 250e in the set of relay nodes 250a: 250e that fulfils an end-to-end link criterion, as evaluated based on the end-to-end wireless link quality metric, is selected.

In some aspects, the user equipment 300a: 300c performs cell reselection by first evaluating the suitability of the wireless access link of each cell. Hence, in some embodiments, it is the cell selection procedure that is performed based on the end-to-end wireless link quality metric, and the user equipment 300a: 300c is further configured to perform optional step S206-b:

S206-b: The user equipment 300a: 300c performs a cell reselection procedure with the relay node 250a: 250e of the relay-assisted wireless network 100 based on the access link characteristics.

For the cells with suitable wireless access links, the user equipment 300a: 300c further ranks them based on the quality of the end-to-end wireless links including both the wireless access link and the wireless backhaul links. In the end, the user equipment 300a: 300c selects the cell with the highest rank value. That is, in some embodiments, the cell reselection procedure identifies a set of relay nodes 250a: 250e fulfilling an access link criterion as evaluated based on the access link characteristics, and during the cell selection procedure the relay node 250a: 250e in the set of relay nodes 250a: 250e having best end-to-end wireless link quality metric is selected.

In some embodiments, both cell selection and reselection are based on the end-to-end wireless link quality metric.

Reference is next made to FIG. 4. In FIG. 4 is provided an illustrative example of a user equipment 300a: 300c cell selection or reselection in a relay-assisted wireless network 100 comprising core network 110, donor node 240 and three relay nodes 250a, 250b, 250c. Each of the donor node 240 and the relay nodes 250a, 250b, 250c provides network access in a respective service area 140a, 140b, 140c, 140d. Wireless backhaul links are illustrated as arrows 120 and wireless access links are illustrated as arrows 130. In the illustrative example, user equipment 300a performs a cell selection or reselection procedure where relay nodes 250b, 250c are identified as potential network nodes for user equipment 300a to camp on. In accordance with embodiments disclosed herein, user equipment 300a is via relay nodes 250b, 250c informed of the quality of the wireless backhaul links 120. User equipment 300a derives an end-to-end wireless link quality metric for the end-to-end wireless link between user equipment 300a and donor node 240 from access link characteristics of the wireless access links 130 and received backhaul link characteristics. In more detail, user equipment 300a is located in an overlapping service area of relay nodes 250b, 250c and can thus detect downlink reference signals transmitted from both relay nodes 250b, 250c. User equipment 300a performs measurements on the downlink reference signals for both cells, and the best RSRP measurements for the wireless access links to relay node 250b and relay nodes 250c are assumed to be −95 dBm and −90 dBm, respectively. The RSRP values of the wireless backhaul links between donor node 240 and relay node 250b, between relay node 250a and relay node 250b are sent from relay node 250b to the user equipment 300a: 300c, and their values are assumed to be −113 dBm and −104 dBm, respectively. The RSRP value of the wireless backhaul link between donor node 240 and relay node 250c is sent from relay node 250c, and its value is assumed to be −120 dBm. If using the criterion of maximum mean RSRP for cell selection, that is, selecting the relay node associated with the end-to-end wireless path which gives the largest mean value of RSRP considering all wireless access links and wireless backhaul links of this path, then, relay node 250c will be selected for the user equipment 300a to connect to. If instead using the criterion of maximum minimum RSRP for cell selection, that is, selecting the relay node associated with the end-to-end wireless path which gives the largest RSRP value of the worst wireless link, then, relay node 250b will be selected for the user equipment 300a to connect to.

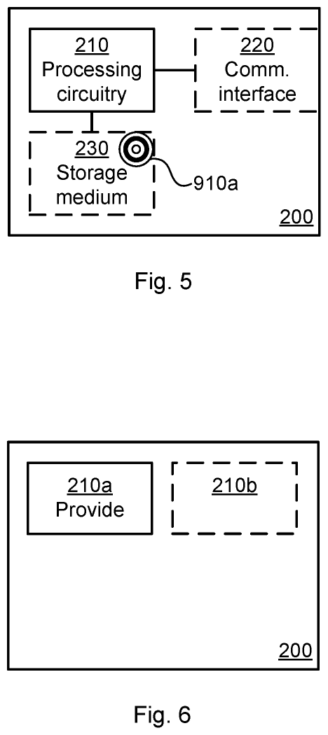

FIG. 5 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910a (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 6 schematically illustrates, in terms of a number of functional modules, the components of a network node 200 according to an embodiment. The network node 200 of FIG. 6 comprises a provide module 210a configured to perform step S102. The network node 200 of FIG. 6 may further comprise a number of optional functional modules, as represented by functional module 210b. In general terms, each functional module 210a: 210b may be implemented in hardware or in software. Preferably, one or more or all functional modules 210a: 210b may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210b and to execute these instructions, thereby performing any steps of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 5 the processing circuitry 210 may be distributed among a plurality of devices, or nodes. The same applies to the functional modules 210a: 210b of FIG. 6 and the computer program 920a of FIG. 9.

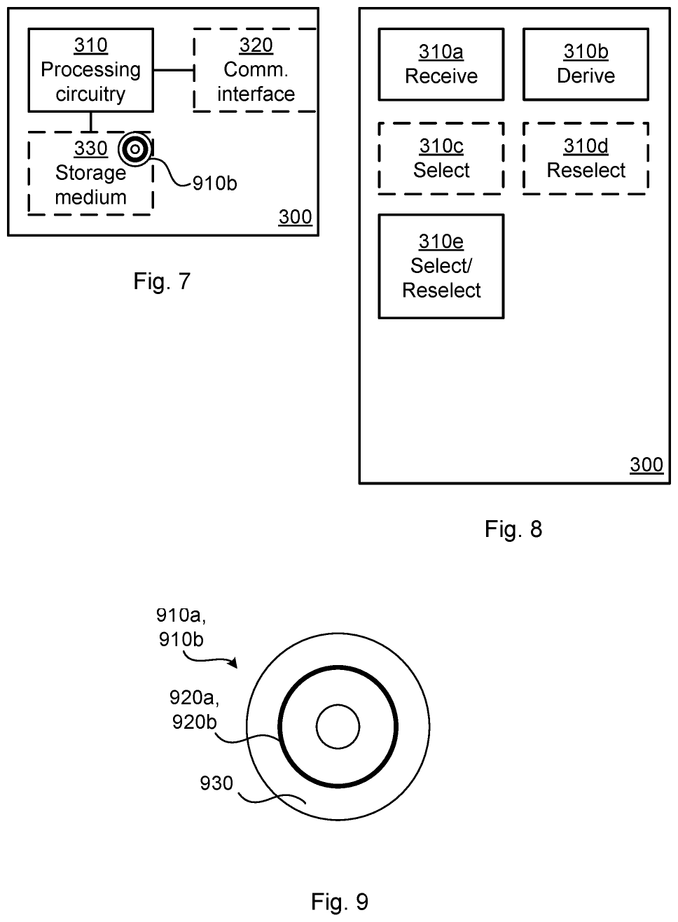

FIG. 7 schematically illustrates, in terms of a number of functional units, the components of a user equipment 300a: 300c according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910b (as in FIG. 9), e.g. in the form of a storage medium 330. The processing circuitry 310 may further be provided as at least one application specific integrated circuit (ASIC), or field programmable gate array (FPGA).

Particularly, the processing circuitry 310 is configured to cause the user equipment 300a: 300c to perform a set of operations, or steps, as disclosed above. For example, the storage medium 330 may store the set of operations, and the processing circuitry 310 may be configured to retrieve the set of operations from the storage medium 330 to cause the user equipment 300a: 300c to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The user equipment 300a: 300c may further comprise a communications interface 320 for communications with other entities, functions, nodes, and devices. As such the communications interface 320 may comprise one or more transmitters and receivers, comprising analogue and digital components.

The processing circuitry 310 controls the general operation of the user equipment 300a: 300c e.g. by sending data and control signals to the communications interface 320 and the storage medium 330, by receiving data and reports from the communications interface 320, and by retrieving data and instructions from the storage medium 330. Other components, as well as the related functionality, of the user equipment 300a: 300c are omitted in order not to obscure the concepts presented herein.

FIG. 8 schematically illustrates, in terms of a number of functional modules, the components of a user equipment 300a: 300c according to an embodiment. The user equipment 300a: 300c of FIG. 8 comprises a number of functional modules; a receive module 310a configured to perform step S202, a derive module 310b configured to perform step S204, and a select/reselect module 310e configured to perform step S208. The user equipment 300a: 300c of FIG. 8 may further comprise a number of optional functional modules, such as any of a select module 310c configured to perform step S206-a, and a reselect module 310d configured to perform step S206-b. In general terms, each functional module 310a: 310e may be implemented in hardware or in software. Preferably, one or more or all functional modules 310a: 310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310e and to execute these instructions, thereby performing any steps of the user equipment 300a: 300c as disclosed herein.

FIG. 9 shows one example of a computer program product 910a, 910b comprising computer readable means 930. On this computer readable means 930, a computer program 920a can be stored, which computer program 920a can cause the processing circuitry 210 and thereto operatively coupled entities and devices, such as the communications interface 220 and the storage medium 230, to execute methods according to embodiments described herein. The computer program 920a and/or computer program product 910a may thus provide means for performing any steps of the network node 200 as herein disclosed. On this computer readable means 930, a computer program 920b can be stored, which computer program 920b can cause the processing circuitry 310 and thereto operatively coupled entities and devices, such as the communications interface 320 and the storage medium 330, to execute methods according to embodiments described herein. The computer program 920b and/or computer program product 910b may thus provide means for performing any steps of the user equipment 300a: 300c as herein disclosed.

In the example of FIG. 9, the computer program product 910a, 910b is illustrated as an optical disc, such as a CD (compact disc) or a DVD (digital versatile disc) or a Blu-Ray disc. The computer program product 910a, 910b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920a, 920b is here schematically shown as a track on the depicted optical disk, the computer program 920a, 920b can be stored in any way which is suitable for the computer program product 910a, 910b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for assisting cell selection or reselection in a relay-assisted wireless network, the method being performed by a network node, the method comprising:
providing, towards a user equipment backhaul link characteristics of a least a first wireless backhaul link, the UE having an end-to-end wireless link comprising a wireless access link and at least the first wireless backhaul link between itself and a donor node of the relay-assisted wireless network, wherein
the backhaul link characteristics provided toward the user equipment are for assisting the user equipment to derive an end-to-end wireless link quality metric for the end-to-end wireless link when performing a cell selection or a reselection procedure.

2. The method of claim 1, wherein the backhaul link characteristics pertain to any of: current or predicted quality of the first wireless backhaul link, performance of the first wireless backhaul link, or/and configuration of the first wireless backhaul link.

3. The method of claim 1, wherein the backhaul link characteristics are provided as a set of wireless backhaul related parameters.

4. The method of claim 3, wherein the wireless backhaul related parameters pertain to any of: RSRP of the first wireless backhaul link, RSRQ of the first wireless backhaul link, SNR of the first wireless backhaul link, SINR of the first wireless backhaul link, latency indicator of the first wireless backhaul link, capacity indicator of the first wireless backhaul link, load indicator of the first wireless backhaul link, priority indicator of the first wireless backhaul link, energy status indicator of the first wireless backhaul link.

5. The method of claim 3, wherein the wireless backhaul related parameters are provided as any of: a list of values, a mean value, a weighted average value, a harmonic mean value, a minimum value, a maximum value.

6. The method of claim 3, wherein the wireless backhaul related parameters are provided towards the user equipment by being broadcasted as system information or transmitted using dedicated radio resource control, RRC, signalling.

7. The method of claim 1, wherein the wireless backhaul related parameters are derived by, or provided to the network node from, the donor node of the relay-assisted wireless network.

8. The method of claim 1, wherein the network node is a relay node, such as an IAB node or a repeater, of the relay-assisted wireless network.

9. The method of claim 1, wherein the network node is the donor node.

10. A method for cell selection or reselection in a relay-assisted wireless network, the method being performed by a user equipment, the user equipment having an end-to-end wireless link comprising a wireless access link and at least a first wireless backhaul link between itself and a donor node of the relay-assisted wireless network, the method comprising:
receiving, from a relay node of the relay-assisted wireless network, backhaul link characteristics of the first wireless backhaul link;
deriving an end-to-end wireless link quality metric for the end-to-end wireless link between the user equipment and the donor node from access link characteristics of the wireless access link and the received backhaul link characteristics; and
performing a cell selection or a reselection procedure with the relay node based on the end-to-end wireless link quality metric.

11. The method of claim 10, wherein the access link characteristics pertain to channel measurements of the wireless access link.

12. The method of claim 10, wherein
it is the cell reselection procedure that is performed based on the end-to-end wireless link quality metric, and
the method further comprises: performing a cell selection procedure with the relay node of the relay-assisted wireless network based on the access link characteristics.

13. The method of claim 12, wherein the cell selection procedure identifies a set of relay nodes fulfilling an access link criterion as evaluated based on the access link characteristics, and wherein during the cell reselection procedure a first available relay node in the set of relay nodes that fulfils an end-to-end link criterion, as evaluated based on the end-to-end wireless link quality metric, is selected.

14. The method of claim 10, wherein
it is the cell selection procedure that is performed based on the end-to-end wireless link quality metric, and
the method further comprises: performing a cell reselection procedure with the relay node of the relay-assisted wireless network based on the access link characteristics.

15. The method of claim 14, wherein the cell reselection procedure identifies a set of relay nodes fulfilling an access link criterion as evaluated based on the access link characteristics, and wherein during the cell selection procedure the relay node in the set of relay nodes having best end-to-end wireless link quality metric is selected.

16. A network node for assisting cell selection or reselection in a relay-assisted wireless network, the network node comprising processing circuitry, the processing circuitry being configured to cause the network node to:
provide, towards a user equipment having an end-to-end wireless link composed of a wireless access link and first wireless backhaul link between itself and a donor node of the relay-assisted wireless network, backhaul link characteristics of the first wireless backhaul link, the backhaul link characteristics assisting the user equipment to derive an end-to-end wireless link quality metric for the end-to-end wireless link when performing a cell selection or a reselection procedure.

17-18. (canceled)

19. A user equipment for cell selection or reselection in a relay-assisted wireless network, the user equipment being configured to have an end-to-end wireless link composed of a wireless access link and first wireless backhaul link between itself and a donor node of the relay-assisted wireless network, the user equipment comprising processing circuitry, the processing circuitry being configured to cause the user equipment to:
receive, from a relay node of the relay-assisted wireless network, backhaul link characteristics of the first wireless backhaul link;
derive an end-to-end wireless link quality metric for the end-to-end wireless link between the user equipment and the donor node from access link characteristics of the wireless access link and the received backhaul link characteristics; and
perform a cell selection or a reselection procedure with the relay node based on the end-to-end wireless link quality metric.

20-24. (canceled)

25. A non-transitory computer readable medium storing a computer program for configuring a network node to perform the method of claim 1.

26. A non-transitory computer readable medium storing a computer program for configuring a user equipment to perform the method of claim 10.
